(19) United States
(12) Patent Application Publication
(10) Pub. No.: US 2009/0199841 A1
(43) Pub. Date: Aug. 13, 2009

(54) Stove cover of infrared barbeque grill

(76) Inventor: Kao Hsung Tsung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/068,778

(22) Filed: Feb. 12, 2008

(51) Int. Cl. A47J 37/07

(52) U.S. Cl. 126/25 R; 99/447

(57) ABSTRACT

A stove cover of an infrared barbeque stove is positioned at the top of the heat generating portion of the stove and includes ventilation holes, each having a blocking plate. When the infrared barbeque stove is used for barbeque, the cover is provided for storing heat to prevent heat loss, and allowing hot air to flow along a specific direction by means of the ventilation holes. Compared with the traditional ceramic cover or high temperature glass cover, the cover of the invention is made of a metal, and thus not only improves the barbeque performance, but also significantly lowers the cost.

### BACKGROUND OF THE INVENTION

1. Field of the Invention

The present invention relates to an improved barbeque grill device, and more particularly to a stove cover of an infrared barbeque grill.

2. Description of the Related Art

In general, an infrared barbeque grill using gas as the fuel usually installs a cover at the top of a heat generating portion of a stove for storing heat to provide a better barbeque effect and protecting flame holes of a heat generating portion of the stove, such that the flame holes will not be stained or clogged by the remained oil.

A common cover installed on the stove is made of a metal sheet or a combination of metal and ceramic, and some covers are made of high temperature glass to give aesthetic appearance and good infrared (radiation heat) penetrability.

Among the aforementioned three materials used for making the cover, the metal cover comes with the lowest price, but the penetrability and heat flow performance of the infrared (radiation heat) are poor in practical applications.

Although the cover made of metal sheets and ceramic lumps has taken the heat flow into consideration, such cover still has the disadvantages of a complicated structure and a high cost, and the oil stains remained after the barbeque are difficult to remove or clear.

Although the cover made of high temperature glass come with a good penetrability, the heat flow is poor, and thus causing a poor burning effect. Furthermore, such cover is fragile and expensive.

In view of the foregoing shortcomings of the prior art, it is a subject for the inventor of the present invention to attempt to overcome the foregoing shortcomings by designing a cover that can store heat and has the durable and low-priced features, a good infrared (radiation heat) penetrability as well as a good heat flow.

### SUMMARY OF THE INVENTION

It is a primary objective of the present invention to overcome the foregoing shortcomings of the prior art by providing a stove cover of an infrared barbeque stove that can store heat and features a good infrared penetrability and a low price.

To achieve the foregoing objective, the present invention provides a stove cover of an infrared barbeque stove, wherein the stove cover is disposed on the stove, and the cover includes a plurality of ventilation holes, each having a blocking plate. When the barbeque grill is used for barbeque, the heat stored at the cover can prevent heat loss, and the hot airflow can flow smoothly along a specific direction by means of the ventilation holes. Compared with the traditional ceramic covers or high temperature glass covers, the covers made of metal not only improve the barbeque performance, but also lower the cost greatly.

During use, the heat produced by a heat generating portion of the stove can be transmitted evenly to the barbeque food through the cover. The middle of the cover is designed at a higher position and both sides of the cover are lower than the middle of the cover and in an arc shape or a roof-shape. The plurality of ventilation holes are designed in a transverse bar shape, and arranged in parallel towards both sides from the middle of the top of the covers. During use, the plurality of ventilation holes are preferably designed sideway into two left and right rows. In addition, the blocking plate of each ventilation hole is proximate to the higher side at the middle of the top, and an opening of the ventilation hole is situated at a lower position.

When food is barbequed, the hot airflow flows smoothly along the direction of the openings of the plurality of ventilation holes, and the blocking plates on the plurality of ventilation holes can prevent food from dropping onto the stove from the ventilation holes, and can also prevent the oil produced by the barbeque from dripping onto flame holes at the heat generating portion of the stove, or prevent the oil from clogging the flame holes.

During use, at least one oil guide groove can be added onto the cover, and the direction of the oil guide groove can be designed perpendicular to the direction of the ventilation holes, so that the debris or oil produced by the barbeque can flow naturally from the cover to the bottom of the oil guide groove and will not be accumulated at a certain particular position, and thus making the cleaning of the cover easy and convenient.

In the embodiment with the design of having the plurality of ventilation holes on two left and right rows, and three oil guide grooves disposed on the left and right rows of the ventilation holes and both external sides, the three oil guide grooves can meet the requirements of providing a smooth flow and collecting the remained oil.

Compared with the prior art, the cover of the present invention is made of metal, and the cover has a plurality of ventilation holes for storing heat to prevent heat loss, and the plurality of ventilation holes allow hot airflow to flow smoothly along a specific direction. In the invention, the cover made of metal provides a better barbeque performance and a lower cost than the traditional cover made of ceramics and high temperature glass.

In addition, the design with blocking plates on ventilation holes and oil guide grooves on the cover can prevent remained oil from dripping onto the heat generating portion of the stove or clogging the flame holes, and such design also prevents remained food from being accumulated on the cover. The invention not only protects the heat generating portion of the stove, but also makes the cleaning of the cover easy and convenient.

### BRIEF DESCRIPTION OF THE DRAWINGS

FIG. 1 is a perspective view of a cover in accordance with a preferred embodiment of the present invention; and

FIG. 2 is a perspective view of a cover installed onto a stove in accordance with a preferred embodiment of the present invention.

### DETAILED DESCRIPTION OF THE PREFERRED EMBODIMENTS

The objective, technical measures and performance of the present invention will become apparent in the detailed description of the preferred embodiments with reference to the accompanying drawings as follows:

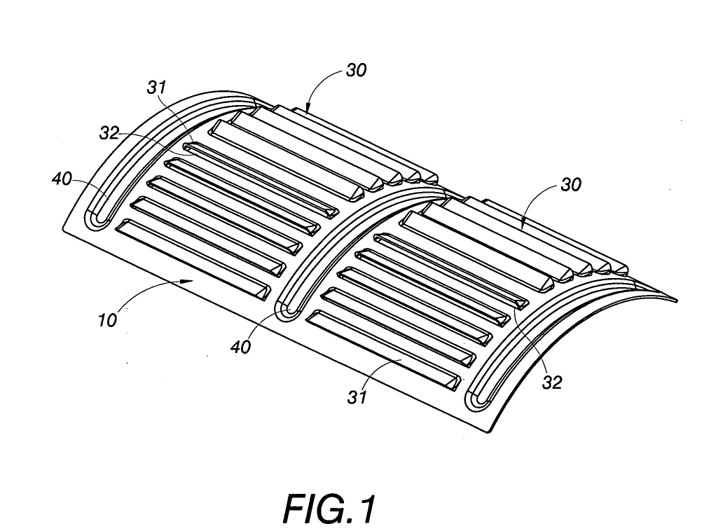

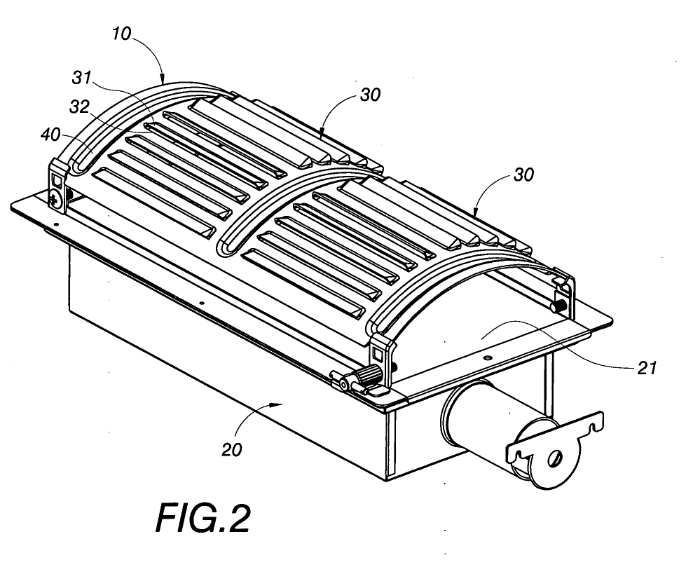

Referring to FIGS. 1 and 2 for a cover 10 of an infrared barbeque stove 20 in accordance with the present invention, the cover 10 is installed at the top of a heat generating portion 21 of the stove 20, and includes a plurality of ventilation holes 30, and each ventilation hole 30 includes a blocking plate 31.

During use, the cover 10 can be designed in an arc shape or a roof-shape for transmitting the heat produced by the heat generating portion 21 of the stove 20 to the barbeque food through the cover 10, and the plurality of ventilation holes 30 can be designed in a transverse long bar shape, and arranged in parallel from the middle of the top of the cover 10 to both lower sides of the cover 10.

In the figure, the plurality of ventilation holes 30 are designed and divided into left and right rows, and blocking plate 31 of each ventilation hole 30 is disposed at a high position proximate to the middle of the top of the cover 10, such that an opening 32 of the ventilation hole 30 is situated at a lower position.

With the aforementioned structure, hot air can flow smoothly along the direction of the opening 32 of the plurality of ventilation holes 30 when food is barbequed on the cover 10, and each blocking plate 31 of the ventilation holes 30 can prevent food from dropping onto the heat generating portion 21 of the stove 20 from the ventilation holes 30, and can also prevent any remained oil from dripping onto the flame holes at the heat generating portion 21 or clogging the flame holes.

During use, at least one oil guide groove 40 can be added to the cover 10, and the oil guide groove 40 can be designed in a direction perpendicular to the plurality of ventilation holes 30, so that the debris or oil produced by the barbeque can flow naturally along the cover 10 to the bottom of the oil guide groove 40 without being accumulated at a certain specific position, and thus making the cleaning of the stove 10 easy and convenient.

To cope with the implementation of the plurality of ventilation holes 30 disposed on both left and right rows, three oil guide grooves 40 are disposed respectively at the middle and both external sides on the left and right rows of the ventilation holes 30, and the three oil guide grooves 40 can meet the requirements for guiding the flow and collecting the waste oils.

Compared with the prior art, the invention provides a cover 10 made of metal and opens a plurality of ventilation holes 30 on the cover 10 for storing heat to prevent heat loss and allowing hot air to flow smoothly along a specific direction through the plurality of ventilation holes 30. Compared with the traditional ceramic cover or the high temperature glass cover, the metal cover of the invention not only improves the barbeque performance, but also lowers the production cost greatly.

In addition, the design of each blocking plate 31 on the ventilation holes 30 and each oil guide groove 40 on the cover 10 can prevent oil from dripping onto the flame holes at the heat generating portion 21 of the stove 20 or clogging the flame holes. This design also prevents remained food from being accumulated on the cover 10, and thus the invention not only protects the heat generating portion 21 of the stove 20, but also makes the cleaning of the cover 10 easy and convenient.

While the invention has been described by means of specific embodiments, numerous modifications and variations could be made by those skilled in the art without departing from the scope and spirit of the invention set forth in the claims.

1. A stove cover of an infrared barbeque stove, the cover being fixed onto a heat generating portion of the stove, and comprising:
a plurality of ventilation holes formed in the cover, each ventilation hole having a blocking plate, the cover having an arc shape with a higher middle portion and lower lateral sides, the plurality of ventilation holes being in a transverse elongated bar shape and arranged in parallel from the middle portion of the cover to the lateral sides,
wherein said blocking plate is disposed at each ventilation hole at a higher side proximate to the middle portion of the cover such that an opening of the ventilation hole is situated at a lower portion of the ventilation hole.

2. (canceled)

3. The stove cover of an infrared barbeque stove as recited in claim 1, wherein the cover further comprises at least one oil guide groove.

4. The stove cover of an infrared barbeque stove as recited in claim 3, wherein the oil guide groove is disposed perpendicular to the plurality of ventilation holes.

5. The stove cover of an infrared barbeque stove as recited in claim 1, wherein the plurality of ventilation holes are arranged sideways into left and right rows.

6. The stove cover of an infrared barbeque stove as recited in claim 5, wherein the cover further comprises three arc-shaped oil guide grooves, each installed at the middle or both sides of the two left and right rows of ventilation holes.

7. The stove cover of an infrared barbeque as recited in claim 1, further comprising:
at least one arc-shape oil guide groove having first and second end portions respectively disposed adjacent said lateral sides.
